(19) United States
(12) Patent Application Publication
(10) Pub. No.: US 2025/0153435 A1
(43) Pub. Date: May 15, 2025

(54) ADDITIVE MANUFACTURING APPARATUS WITH REMOVABLE, EXCHANGEABLE FRAME-LIKE SPACER FOIL

(71) Applicants: SIRONA DENTAL SYSTEMS GMBH, Bensheim (DE); Dentsply Sirona Inc., York, PA (US)

(72) Inventors: Christian SCHMIDT, Bensheim (DE); Andreas SCHAEFER, Rimbach (DE)

(73) Assignee: Dentsply Sirona Inc., York, PA (US)

(21) Appl. No.: 18/730,073

(22) PCT Filed: Jan. 24, 2023
(86) PCT No.: PCT/EP2023/051632

§ 371 Date: Jul. 18, 2024

(30) Foreign Application Priority Data
Jan. 24, 2022 (EP) 22153014.0

(51) Int. Cl. B29C 64/259; B29C 64/245; B29C 64/291; B29C 64/386; B33Y 30/00; B33Y 50/00

(52) U.S. Cl. CPC B29C 64/259; B29C 64/245; B29C 64/291; B29C 64/386; B33Y 30/00; B33Y 50/00

(57) ABSTRACT

The present invention relates to an additive manufacturing apparatus for additively manufacturing a component including: a resin vat unit which includes: a reservoir for storing UV-light photocurable resin; and a frame assembly holding a UV-transparent window at the bottom of the reservoir, said UV-transparent window includes a UV-transparent plate and a UV-transparent anti-adhesive flexible foil; a projection unit for projecting UV-light through the UV-transparent window into the reservoir; and a movable building platform having a surface onto which said component can be formed through layerwise curing of said resin. The UV-transparent window further includes a removable frame-like spacer foil which has a predetermined thickness and can be removably mounted by means of the frame assembly between the UV-transparent plate and the UV-transparent anti-adhesive flexible foil in order to create a plate-foil air gap; and at least one air hole for communicating said plate-foil air gap with the atmosphere.

### TECHNICAL FIELD OF THE INVENTION

The present invention relates to an additive manufacturing apparatus. The present invention more particularly relates to a removable frame-like spacer foil to be used in a UV-transparent window of an additive manufacturing apparatus.

### BACKGROUND ART OF THE INVENTION

In additive manufacturing techniques, such as stereolithography (SLA) or digital light processing (DLP), a three-dimensional component is printed layer-by-layer through light-based curing of a liquid printing medium i.e., a photocurable resin, which is selectively cured under the influence of UV radiation. In a commonly known variation of additive manufacturing, the 3D components are preferably pulled by means of a building platform, upside-down out of the photocurable resin in a resin vat. Other variations of additive manufacturing are also known to those skilled in the art.

According to the state of the art, the resin vat has a UV-transparent window which consists of a UV-transparent, anti-adhesive flexible foil (typically made of a fluoropolymer, e.g., FEP, PMP, Teflon AF, or similar) and a mechanically rigid UV-transparent plate such as glass or Plexiglas. In the state of the art the flexible foil rests on the UV-transparent plate under the weight of the photocurable resin.

When exposing the photocurable resin through the UV-transparent window at the bottom of the resin vat, the polymerized layer adheres to the flexible foil and the building platform. This adhesion to the flexible foil is typically released by a peel-off movement in the Z-direction i.e., in the direction orthogonal to the bottom of the resin vat. The prerequisite for this peel-off is that the anti-adhesive flexible foil can detach from the polymerized layer when the polymerized layer is pulled off by means of the building platform. The detachment of the flexible foil can be described as a peeling process, basically in the same way as a foil or a film is peeled off from a rigid surface.

In the state of the art, the flexible foil is generally disposed onto the UV-transparent plate such that the interface between the foil and the UV-transparent plate is maintained open to the atmosphere so that an air gap can be created, and the foil can assume a convex shape during the peeling process. Usually, the anti-adhesive flexible foil and UV-transparent plate are spaced apart through a rim, collar, or seating flange that is integrally manufactured with the resin vat to maintain the air gap.

US2018/0207867 A1 discloses a method and apparatus for photo-curing photo-sensitive materials for the formation of three-dimensional objects in a tank with a flexible, self-lubricating substratum.

A problem with the prior art is that the force for peeling off the polymerized layer also depends on the size of the area of the polymerized layer, which is also subject to a size limitation of the polymerizable layer within the optical/mechanical limits of the additive manufacturing apparatus.

### DISCLOSURE OF THE INVENTION

The inventors are not aware of any additive manufacturing technology in which a removable, exchangeable frame-like spacer foil is used in a UV-transparent window of an additive manufacturing apparatus to create and maintain an air gap with a specifically desired size in accordance with the apparatus characteristics and printing application.

An objective of the present invention is to overcome the above problems of the prior art and provide an additive manufacturing apparatus which enables an application-dependent, user-adjustable air gap for reducing the force necessary for peeling the UV-transparent anti-adhesive flexible foil from the UV-transparent plate, and increasing the utilization area for additive manufacturing.

This objective has been achieved through the additive manufacturing apparatus as defined in claim 1, and the removable frame-like spacer foil as defined in claim 5. The dependent claims relate to further embodiments and developments.

The present invention provides an additive manufacturing apparatus for additively manufacturing a 3D component. The additive manufacturing apparatus comprises a resin vat unit which has a reservoir for storing UV-light photocurable resin, and a frame assembly holding a UV-transparent window at the bottom of the reservoir, wherein said UV-transparent window includes a UV-transparent plate and a UV-transparent anti-adhesive flexible foil. The additive manufacturing apparatus further comprises a projection unit for projecting UV-light through the UV-transparent window into the reservoir; and a movable building platform having a surface onto which said 3D component can be formed through layerwise curing of the said resin. The UV-transparent window further includes: a removable frame-like spacer foil which has a predetermined thickness and can be removably mounted within the frame assembly between the UV-transparent plate and the UV-transparent anti-adhesive flexible foil in order to create a plate-to-foil air gap; and at least one air hole for communicating said plate-to-foil air gap with the atmosphere.

For comparison with the present invention, the prior art resin vat is manufactured with an integral collar that generally involves stringent requirements because the collar height must be circumferentially uniform, and assume a precise value within a range of several micrometers to several millimeters depending on the apparatus characteristics. The prior art manufacturing process is generally achieved by a milling process or molding process of the resin vat with the integral collar. Unlike the present invention, in the prior art the collar height of the resin vat cannot be changed or adjusted after manufacture of the vat in accordance with the apparatus characteristics and printing application.

The present invention enables the user to set different spacings between the UV-transparent anti-adhesive flexible foil and the UV-transparent plate inside the UV-transparent window. Basically, this is achieved through the removable frame-like spacer foil provided in the thickness of the desired spacing. The thickness of removable frame-like spacer foil can be selected accordingly depending on the printing requirements. The user may retrofit the resin vat unit with the removable frame-like spacer foil having the desired thickness.

According to the present invention, the resin vat unit can be provided as a unit which can be entirely removed from the additive manufacturing apparatus. Therefore, in a preferred embodiment, the reservoir and the frame assembly including the UV-transparent window are configured to define a detachable resin vat unit which can be detached through a detachment mechanism, for instance pulled out, through a user from the additive manufacturing apparatus. Thereby the user can take the resin vat unit to the outside, for instance, for replenishment of fresh resin. The user may also retrofit the resin vat unit with a frame-like spacer foil with the desired thickness in accordance with the printing requirements after it has been taken out of the additive manufacturing apparatus. Alternatively, the resin vat unit can be provided as a unit which is partly or entirely integrated with the additive manufacturing apparatus.

A major advantageous effect of the present invention is that the adaptation of various spacings between the flexible foil and rigid plate becomes possible for different printing applications, and thus the additive manufacturing, in specific the resin vat unit does not have to be exchanged entirely but only retrofitted with a frame-like spacer foil with the desired thickness.

Another major advantageous effect of the present invention is that the peeling forces can be reduced by increasing the thickness of the spacing, thereby also the duration of the overall printing process can be shortened as the peeling process can be speeded-up.

Another major advantageous effect of the present invention is that the area utilization of the projection area can be comparatively increased within the mechanical limits of the additive manufacturing apparatus by way of using comparatively thicker spacer foils.

### BRIEF DESCRIPTION OF THE DRAWINGS

In the subsequent description, further aspects and advantageous effects of the present invention will be described in more detail by using exemplary embodiments and by referring to the drawings, wherein

FIG. 1—is a schematic vertical cross-sectional partial view of a stereolithography apparatus according to an embodiment;

FIG. 2—is a schematic perspective view of an entirely detachable resin vat unit of the stereolithography apparatus according to an embodiment;

FIG. 3—is a schematic perspective exploded view of the resin vat unit in FIG. 2;

FIG. 4A—is a schematic perspective upper view of an inner frame of the frame assembly of the resin vat unit in FIG. 3;

FIG. 4B—is a schematic perspective lower view of the inner frame in FIG. 4A;

FIG. 5A—is a schematic cross-sectional view of the inner frame in FIG. 4B, taken along the line I-I;

FIG. 5B—is a schematic enlarged view of the detail II in FIG. 5A;

FIG. 6—is a schematic top view of the removable frame-like spacer foil;

FIG. 7—is a schematic top view of the UV-transparent anti-adhesive flexible foil.

1. Stereolithography apparatus
2. Component
3. Resin vat unit
4. Reservoir
   4a. Aperture
   4b. Grip
5. UV-light photocurable resin
6. Frame assembly
   6-1. Inner frame
      6-1a. Inner frame element
      6-1b. Inner frame element
      6-1c. Screw
      6-1d. Screw hole
   6-2. Outer frame
      6-2a. Air hole
      6-2b. Air channel
      6-2c. Hose
      6-2d. Screw
      6-2d′ Screw
      6-2e. Screw hole
      6-2e′ Screw hole
   6-3. Sealing
      6-4 UV-transparent window
      6-4a. UV-transparent plate
      6-4b. UV-transparent anti-adhesive flexible foil
      6-4c. Removable frame-like spacer foil
      6-4d. Plate-foil air gap
7. Projection unit
8. UV-light
9. Movable building platform
   9a. Surface

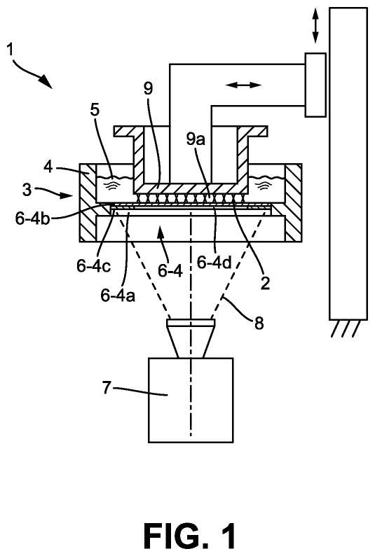

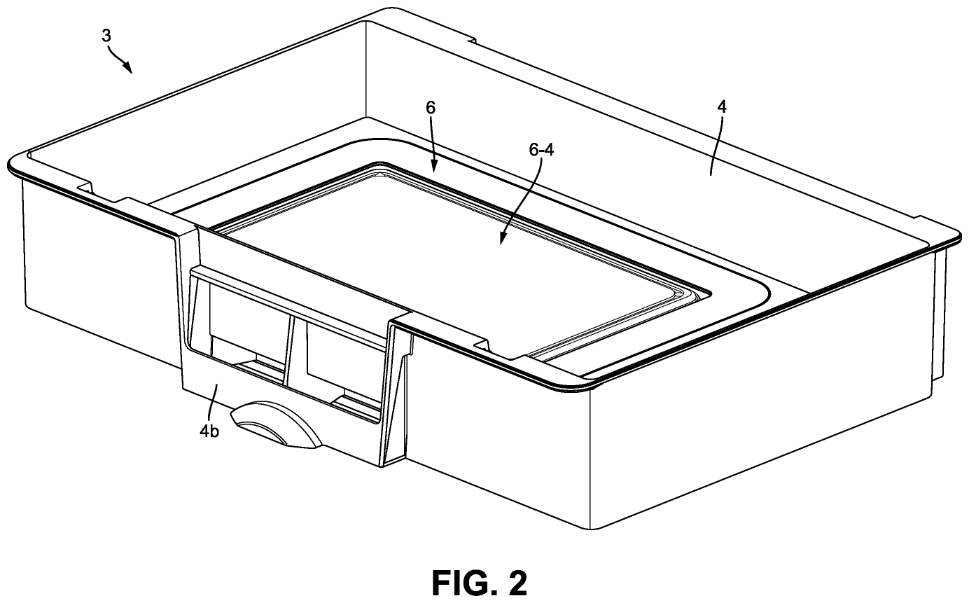

FIG. 1 shows an embodiment of an additive manufacturing apparatus (1) for additively manufacturing a 3D component (2). As shown in FIG. 2, the additive manufacturing apparatus (1) has a resin vat unit (3) which includes a reservoir (4) for storing UV-light photocurable resin (5), and a frame assembly (6) holding a UV-transparent window (6-4) at the bottom of the reservoir (4). As shown in FIG. 1, said UV-transparent window (6-4) includes a UV-transparent plate (6-4a) and a UV-transparent anti-adhesive flexible foil (6-4b). As shown in FIG. 1, the additive manufacturing apparatus (1) has a projection unit (7) for projecting UV-light (8) through the UV-transparent window (6-4) into the reservoir (4). The additive manufacturing apparatus (1) includes a transportation unit which comprises a movable building platform (9) that has a surface (9a) facing the bottom of the resin vat unit (3) onto which said 3D component (2) can be formed through layerwise curing of said resin (5) through the projection unit (7). The building platform (9) can be moved into and out of the reservoir (4) by the transport unit. The building platform (9) can be also moved sideways within the reservoir (4) by the transport unit. The additive manufacturing apparatus (1) has a computer-implemented control device for controlling the projection unit (7) and the transport unit, and overall functioning.

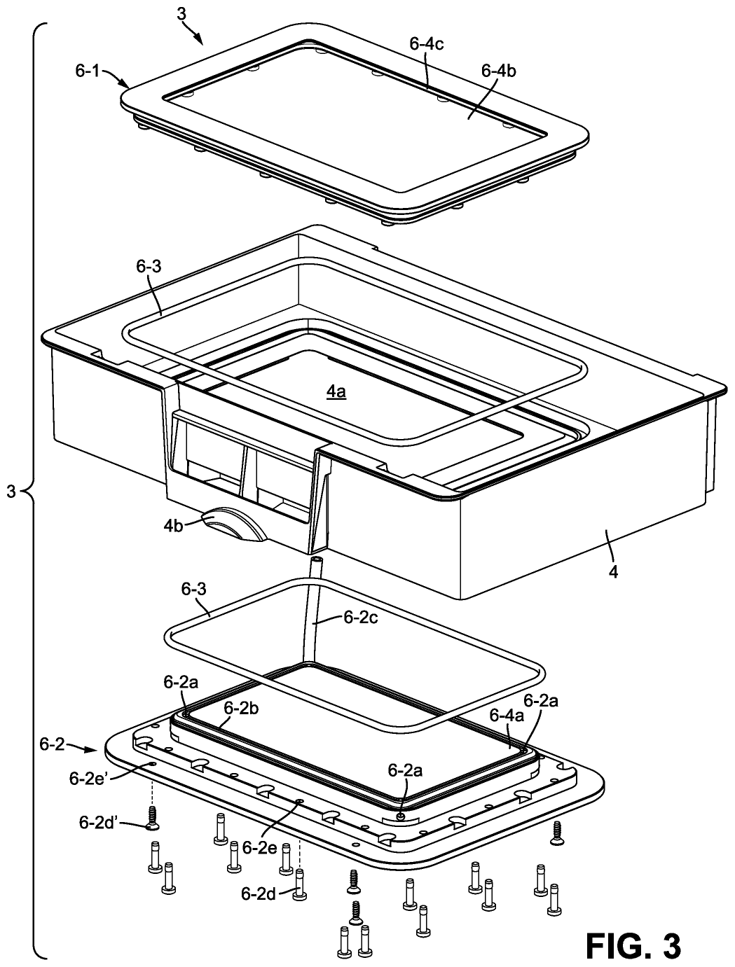

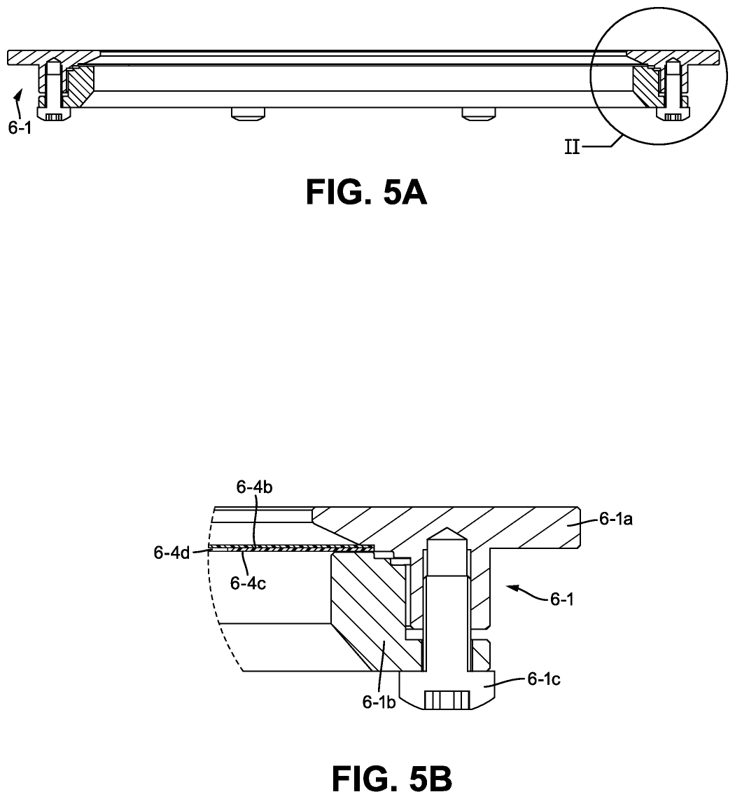

As shown in FIG. 1, the UV-transparent window (6-4) further includes a removable frame-like spacer foil (6-4c) which has a predetermined thickness. As shown in more detail in FIG. 5B, the removable frame-like spacer foil (6-4c) can be mounted by means of the frame assembly (6) between the UV-transparent plate (6-4a) and the UV-transparent anti-adhesive flexible foil (6-4b) in order to create a plate-foil air gap (6-4d). The details of the frame assembly (6) will be explained later in more detail. As shown in FIG. 3, the UV-transparent window (6-4) has air holes (6-2a) for communicating said plate-foil air gap (6-4d) with the atmosphere.

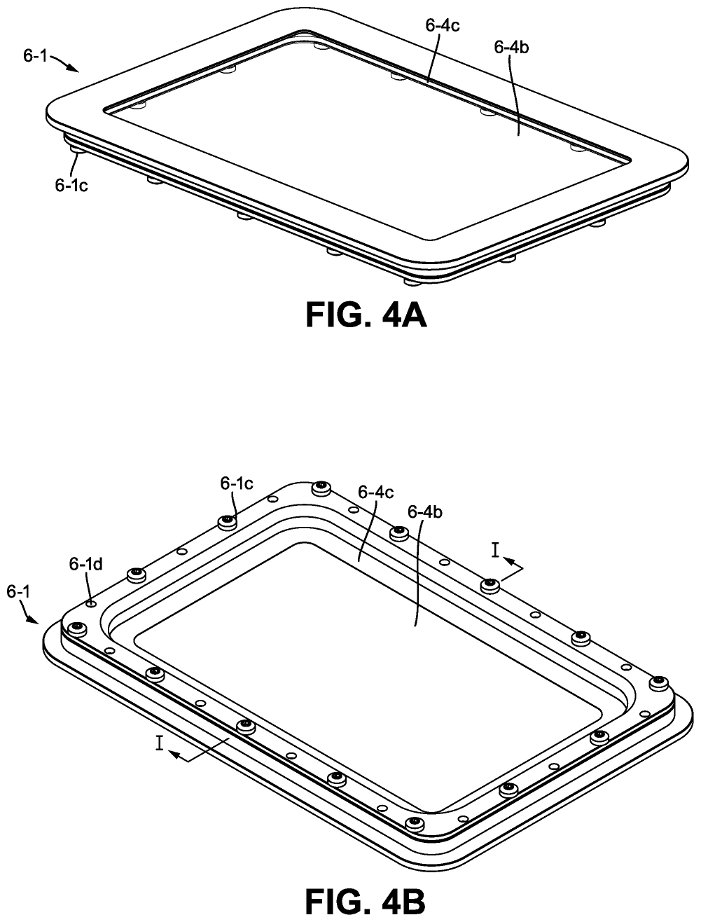

Hereinafter, the frame assembly (6) will be explained in more detail. As shown in FIG. 3, the frame assembly (6) comprises an inner frame (6-1) and an outer frame (6-2) which are respectively mounted on the inner side and the outer side of the aperture (4a) of the resin vat unit (3). A sealing (6-3) is preferably arranged between the interface of the inner frame (6-1) and the resin vat unit (3). Another sealing (6-3) is preferably arranged between the interface of the inner frame (6-1) and the outer frame (6-2). As shown in FIG. 5B, the inner frame (6-1) has two inner frame elements (6-1a; 6-1b) which are attached to each other through the screws (6-1c). The screws (6-1c) can be easily removed by the user to exchange the removable frame-like spacer foil (6-4c). The UV-transparent anti-adhesive flexible foil (6-4b) and the removable frame-like spacer foil (6-4c) are sandwiched/clamped between the two inner frame elements (6-1a; 6-1b). As shown in 5B, a plate-foil air gap (6-4d) is created by means of the frame-like spacer foil (6-4c) above the UV-transparent plate (6-4a) when these are assembled. As shown in FIG. 3, the UV-transparent plate (6-4a) is fixed on the outer frame (6-2) for example with an adhesive. The outer frame (6-2) has an air hole (6-2a) at each corner which are preferably connected with each other through a peripherally running air channel (6-2b). The frame-like spacer foil (6-4c) has a width such that it does not entirely cover the air holes (6-2a) and the air channel (6-2b). The air hole (6-2a) is preferably connected with a hose (6-2c) with the atmosphere. The outer frame (6-2) has screw holes (6-2e) for letting through the screws (6-2d) which are screwed into screw holes (6-1d) (see FIG. 4B). The outer frame (6-2) has also screw holes (6-2e′) for letting through the screws (6-2d′) which are screwed into screw holes (not shown) on the outer side of the resin vat unit (3). In the assembled state, the frame-like spacer foil (6-4c) is sandwiched between the UV-transparent anti-adhesive flexible foil (6-4b) and the UV-transparent plate (6-4a), and thereby together define the UV-transparent window (6-4a). The weight of the photocurable resin (5) in the resin vat unit (3) causes a deflection of the UV-transparent anti-adhesive flexible foil (6-4b) max. down to the thickness of the frame-like spacer foil (6-4c). Thus, the plate-foil air gap (6-4d) may have a non-uniform shape depending on the tension of the flexible foil (6-4b) and the weight of the photocurable resin (5). The flexible foil (6-4b) may have a purely concave deflection or a partially concave deflection at the periphery in combination with a parallel contact to the UV-transparent plate (6-4a) around the center depending on the tension of the flexible foil (6-4b) and the weight of the photocurable resin (5). The screws (6-2d) can be used also to adjust the tension on the flexible foil (6-4b) when the inner frame (6-1) is clamped to the outer frame (6-2) with the elastic sealing (6-3) located in-between. The tighter the screws (6-2d) are fixed, the higher becomes the tension on the flexible foil (6-4b). As the screws (6-2d) are tightened, the edges of the UV-transparent anti-adhesive flexible foil (6-4b) and frame-like spacer foil (6-4c) are pulled relatively down, while riding over the rounded edge of the plate (6-4a), and thus stretched across the UV-transparent plate (6-4a) and accordingly pressed against the latter due to the relative movement of the inner frame (6-1) towards the outer frame (6-2). Thus, the inner frame (6-1), the outer frame (6-2), the screws (6-2d), the elastic sealings (6-3) define a means for tensioning the UV-transparent anti-adhesive flexible foil (6-4b). The tension is adjustable.

In an embodiment, the reservoir (4) and the frame assembly (6) including the UV-transparent window (6-4) are configured to define a detachable resin vat unit (3) which can be entirely detached through the user and taken manually out of the additive manufacturing apparatus by means of a detachment mechanism. In this embodiment, the resin vat unit (3) preferably has a hand grip (4b).

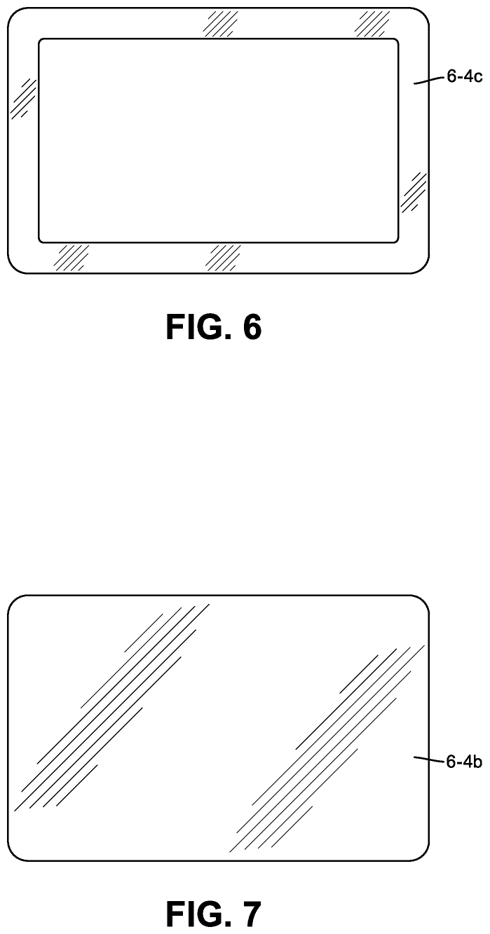

In an embodiment, the anti-adhesive flexible foil (6-4b) has preferably a rectangular area of about 107.7×166.5 mm, and preferably a thickness of 0.127 mm. But foils (6-4b) with different dimensions that are large or smaller may be used. The removable frame-like spacer foil (6-4c) is preferably provided with a thickness of at least 100 micrometers. Thereby, the specific pull-off forces can be reduced below 30N by a 60% area utilization of the available projection foil area of about 134.4 mm×75.6 mm, which is suitable for dental applications such as aligners, bite splints, models, drilling templates, dentures, and the like. Different area utilization may be used. If the utilization of the available projection foil area is even smaller, the removable frame-like spacer foil (6-4c) can be preferably provided with a smaller thickness of at least 50 micrometers. A smaller height would not adequately meet the peel off requirements. Therefore, the said thickness is preferably in the range of 50-150 μm, more preferably in the range of 150-200 μm, or even more preferably at least 200 μm. As shown in FIG. 6, the removable frame-like spacer foil (6-4c) has preferably a rectangular shaped opening in the middle thereof to secure the plate-foil air gap (6-4d) in the assembled state. FIG. 7, shows the UV-transparent anti-adhesive flexible foil (6-4b) which has preferably the same outer contour with the removable frame-like spacer foil (6-4c) in FIG. 6. The surrounding frame-width of the removable frame-like spacer foil (6-4c) is preferably about 13 mm, and has preferably also rounded corners. Different widths which are large or smaller may be used. The removable frame-like spacer foil (6-4c) can be made of the same material of the UV-transparent anti-adhesive flexible foil (6-4b). Alternatively, the removable frame-like spacer foil (6-4c) can be preferably produced from different materials such as plastic, metal, ceramic, or paper in the form of thin sheets.

The UV-transparent anti-adhesive flexible foil (6-4b) can be manufactured from any of the following plastic materials: Fluor polymers such as Fluorinated ethylene propylene (FEP), Polytetrafluoroethylene (PTFE), Ethylene Tetrafluoroethylene (ETFE), Perfluoralkoxy-Polymer (PFA), Teflon AF™, Polyvinyl fluoride (PVF), Polyvinylidene fluoride (PVDF).

The removable frame-like spacer foil (6-4c) can be manufactured for example from any of the following plastic materials: Plastic polymers such as Polyethylene (PE), Polypropylene (PP), Polymethylmethacrylate (PMMA), Polyvinylchloride (PVC), Polycarbonate (PC).

The above-mentioned metal materials can be metals such as Aluminum, Aluminum based alloys, Copper based alloys, Stainless steel.

The above-mentioned ceramic materials can be ceramics such as Alumina, Zirconia, Silicon carbide, Silicon nitride.

Furthermore, in an embodiment, the removable frame-like spacer foil (6-4c) can be provided in different colors or with color code markings which are visible from the outside, and can allow the user to distinguish between different sizes, thicknesses, and materials thereof. Hereto, the user may refer to a look-up table in a user manual or the display of the user interface of the additive manufacturing apparatus (1) regarding the color codes. The additive manufacturing apparatus (1) has a memory storing such information or may retrieve them from an external memory, preferably located in the cloud or the local area network. The additive manufacturing apparatus (1) may be connectable to the local area network, or the internet for receiving/sending data relating to the printing job and/or other information which will be described later in more detail.

Before the printing process is started, the user may manually enter via the user interface or by means an optical reader unit such as scanner (camera/barcode reader etc.) of the additive manufacturing apparatus (1), information on the type of the resin vat unit (3) attached, and/or specifically the information relating to the characteristics of the spacer foil (6-4c) mounted to the resin vat unit (3), such as the size, thickness, material, and/or color. Hereto, default or user-generated barcode labels or QR codes labels or the like can be used on the resin vat unit (3) which store such information. Alternatively, or additionally a mobile phone camera or an intraoral scanner connectable to the system comprising the additive manufacturing apparatus (1) can be used as the optical reader unit.

Furthermore, in an embodiment the detachable resin vat unit (3) is preferably alternatively or additionally provided with an RFID tag (not shown) that includes such information of the type of the resin vat unit (3), and information on the presence/absence of the removable frame-like spacer foil (6-4c) in the UV-transparent window (6-4). In addition, any combination of information on the thickness, size, material, and/or color of the removable frame-like spacer foil (6-4c) can also be saved in the RFID tag. In addition, the additive manufacturing apparatus (1) is preferably provided with an RFID reader/writer. Thereby the additive manufacturing apparatus (1) can recognize type of the attached resin vat unit (3) attached and whether it comprises a spacer foil (6-4c) or not, retrieve said information on the spacer foil (6-4c), and optionally display to the user the above-mentioned information via the user interface of the additive manufacturing apparatus (1), and apply the required printing mode.

The control device is adapted to perform the control in accordance with the information input by the user and/or read from the RFID tag or the label. The control is implemented through a software. The control device may prompt the user via the user interface to mount a spacer foil (6-4c) with a required/sufficient minimum thickness that suits the printing job, in particular the area utilization, the resin type, and further accordingly adapt the peeling forces to be applied by the transport unit.

The user can also edit the RFID tag via the user interface in accordance with any changes he/she made to the resin vat unit (3), for example, after retrofitting or exchanging the removable frame-like spacer foil (6-4c) with a different one.

The resin vat unit (3) may be provided with a detachable replenishment cartridge (not shown) including a specific UV-light photocurable resin (5) for replenishing the reservoir (4). One or more RFID tags and/or labels may be provided on the wall of the reservoir (4) and/or directly on the detachable replenishment cartridge. The RFID tag and/or label may also include information on the type of the specific UV-light photocurable resin (5). Thereby, different UV-light photocurable resin (5) may be recognized and used by the additive manufacturing apparatus (1) for different dental applications. The control device is adapted to perform the control in accordance with type of the UV-light photocurable resin (5) recognized.

The resent invention also provides a method of additively manufacturing of a component (2), by using the additive manufacturing apparatus (1) of the present invention, in particular by using the removable frame-like spacer foil (6-4c) of the detachable resin vat unit (3) to adjust peeling forces, determine optimum utilization area, wherein the control device accordingly adapts the peeling forces to be applied by the transport unit in accordance with the thickness of the removable frame-like spacer foil (6-4c).

1. An additive manufacturing apparatus for additively manufacturing a component comprising:
a resin vat unit which comprises: a reservoir for storing UV-light photocurable resin; and a frame assembly holding a UV-transparent window at a bottom of the reservoir, wherein said UV-transparent window includes a UV-transparent plate and a UV-transparent anti-adhesive flexible foil;
a projection unit for projecting UV-light through the UV-transparent window into the reservoir;
a movable building platform having a surface onto which said component can be formed through layerwise curing of said resin;
wherein the UV-transparent window further includes a removable, exchangeable frame-like spacer foil which has a predetermined thickness and is removably mountable by means of the frame assembly between the UV-transparent plate and the UV-transparent anti-adhesive flexible foil in order to create a plate-foil air gap; and
at least one air hole for communicating said plate-foil air gap with the atmosphere.

2. The additive manufacturing apparatus according to claim 1, wherein the reservoir and the frame assembly including the UV-transparent window are configured to define a detachable resin vat unit which is detachable through a user from the additive manufacturing apparatus.

3. The additive manufacturing apparatus according to claim 2, further comprising an RFID tag reader/writer, wherein the resin vat unit comprises one or more RFID tags that store information relating to the type of the resin vat unit and information relating to the removable frame-like spacer foil.

4. The additive manufacturing apparatus according to claim 2, further comprising an optical reader unit, wherein the resin vat unit comprises one or more optically readable labels that store information relating to the type of the resin vat unit and information relating to the removable frame-like spacer foil.

5. A removable frame-like spacer foil suitable for use in the additive manufacturing apparatus according to claim 1.

6. The removable frame-like spacer foil according to claim 5, wherein the removable frame-like spacer foil is provided with one or more color codes indicative of the thickness, material, and/or size thereof.

7. The removable frame-like spacer foil according to claim 5, wherein the removable frame-like spacer foil has a thickness of at least 100 micrometers.
